(19) United States
(12) Patent Application Publication
(10) Pub. No.: US 2024/0340500 A1
(43) Pub. Date: Oct. 10, 2024

(54) ACTIVITY REMINDERS

(71) Applicant: Sony Group Corporation, Tokyo (JP)

(72) Inventor: Marvin DeMerchant, San Diego, CA (US)

(73) Assignee: Sony Group Corporation, Tokyo (JP)

(21) Appl. No.: 18/130,848

(22) Filed: Apr. 4, 2023

(51) Int. Cl. H04N 21/472; H04N 21/433; H04N 21/845

(52) U.S. Cl. CPC H04N 21/47214; H04N 21/4334; H04N 21/8456

(57) ABSTRACT

Implementations generally relate to television viewing. In some implementations, a method includes detecting a program being presented on a television. In some implementations, a method includes recording a play time period that the television has been showing the program. In some implementations, the method includes determining when the play time period meets a predetermined threshold value. In some implementations, the method includes determining a target break point in the program in response to the play time period meeting the predetermined threshold value. In some implementations, the method includes presenting a reminder notification to a user during the target break point.

### BACKGROUND

Mobile devices such as personal wearable devices often have a feature or application for providing reminders to users. For example, a mobile device may provide activity reminders for activities such as exercise. These reminders may set by the user at a particular time of day.

### SUMMARY

Implementations generally relate to activity reminders. In some implementations, a system includes one or more processors, and includes logic encoded in one or more non-transitory computer-readable storage media for execution by the one or more processors. When executed, the logic is operable to cause the one or more processors to perform operations including: detecting a program being presented on a television; recording a play time period that the television has been showing the program; determining when the play time period meets a predetermined threshold value; determining a target break point in the program in response to the play time period meeting the predetermined threshold value; and presenting a reminder notification to a user during the target break point.

With further regard to the system, in some implementations, the predetermined threshold value is a maximum of time before initiating a reminder event. In some implementations, the target break point is between a previous episode of the program and a next episode of the program. In some implementations, the predetermined threshold value is based on a number of episodes. In some implementations, the predetermined threshold value is based on a number of minutes. In some implementations, the reminder notification indicates the predetermined threshold value has been met. In some implementations, the user is a person watching a program on the television.

In some implementations, a non-transitory computer-readable storage medium with program instructions thereon is provided. When executed by one or more processors, the instructions are operable to cause the one or more processors to perform operations including: detecting a program being presented on a television; recording a play time period that the television has been showing the program; determining when the play time period meets a predetermined threshold value; determining a target break point in the program in response to the play time period meeting the predetermined threshold value; and presenting a reminder notification to a user during the target break point.

With further regard to the computer-readable storage medium, in some implementations, the predetermined threshold value is a maximum of time before initiating a reminder event. In some implementations, the target break point is between a previous episode of the program and a next episode of the program. In some implementations, the predetermined threshold value is based on a number of episodes. In some implementations, the predetermined threshold value is based on a number of minutes. In some implementations, the reminder notification indicates the predetermined threshold value has been met. In some implementations, the user is a person watching the program on the television.

In some implementations, a method includes: detecting a program being presented on a television; recording a play time period that the television has been showing the program; determining when the play time period meets a predetermined threshold value; determining a target break point in the program in response to the play time period meeting the predetermined threshold value; and presenting a reminder notification to a user during the target break point.

With further regard to the method, in some implementations, the predetermined threshold value is a maximum of time before initiating a reminder event. In some implementations, the target break point is between a previous episode of the program and a next episode of the program. In some implementations, the predetermined threshold value is based on a number of episodes. In some implementations, the predetermined threshold value is based on a number of minutes. In some implementations, the reminder notification indicates the predetermined threshold value has been met. In some implementations, the user is a person watching the program on the television.

A further understanding of the nature and the advantages of particular implementations disclosed herein may be realized by reference of the remaining portions of the specification and the attached drawings.

### BRIEF DESCRIPTION OF THE DRAWINGS

FIG. 1 is a block diagram of an example environment for regulating television viewing time, which may be used for implementations described herein.

FIG. 2 is an example flow diagram for regulating television viewing time, according to some implementations.

FIG. 3 is a block diagram of an example timing diagram associated with regulating television viewing time, according to some implementations.

FIG. 4 is a block diagram of an example network environment, which may be used for some implementations described herein.

FIG. 5 is a block diagram of an example computer system, which may be used for some implementations described herein.

### DETAILED DESCRIPTION

Implementations described facilitate in regulating television viewing time using activity reminders. Implementations help to reduce unintentional media consumption by detecting continual media consumption and making periodic reminders to the user of activities alternative to watching television. Implementations suggest other activities by displaying images or animations at predetermined break points.

As described in more detail herein, in various implementations, a system detects a program being presented on a television. The system further records a play time period that the television has been showing the program. The system further determines when the play time period meets a predetermined threshold value. The system further determines a target break point in the program in response to the play time period meeting the predetermined threshold value. The system further presents a reminder notification to a user during the target break point.

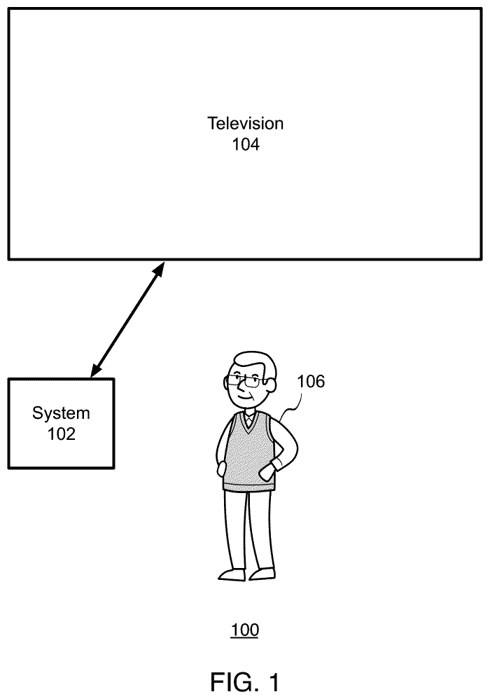

FIG. 1 is a block diagram of an example environment 100 for regulating television viewing time, which may be used for some implementations described herein. As shown, in various implementations, environment 100 includes a system 102 and a television 104. System 102 and television 104 may communicate directly via any suitable means such as network (not shown) such as a Bluetooth network, a Wi-Fi network, etc. While system 102 and television 104 are shown separately, in some implementations, system 102 may be integrated with television 104.

In various implementations, environment 100 may not have all of the components shown and/or may have other elements including other types of elements instead of, or in addition to, those shown herein.

While system 102 performs implementations described herein, in other implementations, any suitable component or combination of components associated with system 102 or any suitable processor or processors associated with system 102 may facilitate performing the implementations described herein.

In various implementations, any neural networks and/or blockchain networks associated with system 102 may also facilitate performing the implementations described herein. For example, the system may perform various operations associated with implementations described herein using a neural network (not shown). The system may process any collected information through the neural network, which adapts or learns based on the collected information. The neural network may also be referred to as an artificial intelligence neural network or neural net. Example implementations directed to AI, machine learning, and neural networks are described in more detail herein.

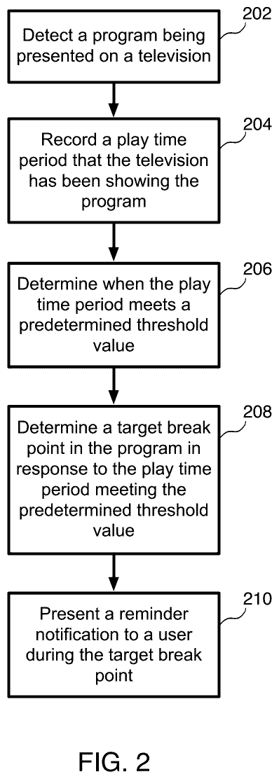

FIG. 2 is an example flow diagram for regulating television viewing time, according to some implementations. Referring to both FIGS. 1 and 2, a method is initiated at block 202, where a system such as system 102 detects a program being presented on a television. In various implementations described herein, the program may be delivered to television 104 by any suitable means. For example, the program may be sourced by a cable network, streaming from a video platform (e.g., YouTube, etc.), from a traditional television broadcast station, etc.

At block 204, the system records a play time period that the television has been showing the program. For example, the start of a play time period may be at the beginning of a program.

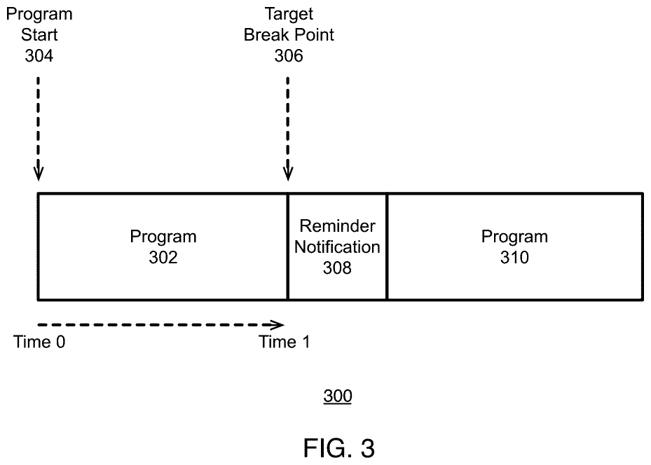

FIG. 3 is a block diagram of an example timing diagram associated with regulating television viewing time, according to some implementations. Shown is a program 302, which has a program start 304. Program start 304 may also be referred to as Time 0. Program 302 may represent any television program that is shown on the television (e.g., cooking program, sports program, movie, television series, etc.).

Referring still to FIG. 2, at block 206, the system determines when the play time period meets a predetermined threshold value. In various implementations, the predetermined threshold value is a maximum of time before initiating a reminder event. In various implementations, the predetermined threshold value is based on a number of minutes. The predetermined threshold value may vary and will depend on the particular implementation. For example, the maximum time may be 30 minutes, 1 hour, 2 hours, etc.

In various implementations, the predetermined threshold value is based on a number of episodes. The particular number may vary and will depend on the particular implementation. For example, the predetermined threshold number of episodes of the program that have been shown consecutively may be 2 episodes, 3 episodes, 4 episodes, etc.

At block 208, the system determines a target break point in the program in response to the play time period meeting the predetermined threshold value. In various implementations, the target break point is between a previous episode of the program and a next episode of the program. In the example shown in FIG. 3, a target break point 306 occurs at the end of program 302. Here, target break point 306 occurs at the end of program 302. The target break point 306 may also be referred to as Time 1.

In various implementations, the target break point may be any natural break during the users viewing. The particular target break point may vary depending on the particular implementation. For example, in some implementations, target break point 306 may be a moment when the television program is paused by the user. In another example, the target break point 306 may be a moment when there is a commercial break, etc. In another example, the target break point 306 may be the inactivity when a screensaver may start. This could be a break point or proactive interruption to encourage someone to not watch TV. For example, the system may present a weather report and one or more suggested outdoor activities (e.g., hike, farmers marker, etc.).

In some implementations, the system may adjust the number of reminders during certain times of day. For example, the system may reduce the number of reminders during late evenings close to bedtime when people are generally relaxing. In some implementations, the system may present particular types of reminders during certain times of day (e.g., recommend daily events in the morning, recipes before dinner etc.).

At block 210, the system presents a reminder notification to a user during the target break point. Referring still to FIG. 3, the system presents reminder notification 308 between program 302 and a program 310.

In various implementations, the reminder notification indicates the predetermined threshold value has been met. In various implementations, the reminder notification may include words or images presented by the television at predetermined break points. Such predetermined break points may include time between programs or episodes, during commercials, on a pause, when the display is not being actively used, etc.

In some implementations, the reminder notification may be words that the system displays on the television screen that remind the user of alternative activities to watching television (e.g., “Good time for an exercise break.” “Take a break to work in the garden.” etc.). In some implementations, the reminder notification may be images that the system displays on the television screen that remind the user of alternative activities to watching television (e.g., an image of an exercise bike, an image of a kitchen garden, etc.).

In various implementations, the system may use artificial intelligence (AI) to create the reminder notifications. Using AI, the system may detect activities from sensed behavioral patterns or linked accounts. The system may generate notification reminders indicating these activities.

In various implementations, the system may collect and analyze any personal available information for past and future activities of the user. For example, the system may access linked accounts including calendars, photo albums, location data, bucket lists, and/or to-do lists. Activities may include exercising, working in the garden, walking the dog, playing with children, making dinner, doing laundry, studying, etc. The system may access photos of the user jogging on a path, spending time with family, working in the garden, etc. Activities may also be selected by users from a list or may be suggested based on other detected activities. In various implementations, the system may enable users to perform activities, purchase tickets, products, trips, connect to other people with similar interests, etc.

In various implementations, the system may enable a user to select and/or edit reminders. For example, the system may enable a parent user to insert a reminder that a child would have to finish his or her homework before continuing watching television. The system may, for example, display a prompt on the television screen, “Have you finished your homework? Yes or No. If Yes is selected, the system may allow the program to continue being watched. If No is selected, the system may stop the program from being watched.

In various implementations, the system may provide different notification reminders for different members of a family based on associated activities for those detected to be in the room. The system may detect those in the room based on a camera.

In various implementations, the user is a person watching the program on the television. In some implementations, the user is not a person watching the program on the television. For example, in some implementations, the user may be a parent user who is not watching television, where a child of the parent user is watching television. In this example scenario, the system may send the parent user the reminder notification, which may remind the parent user to check on the child to make sure the child is not watching the television for too long.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

As indicated herein, in various implementations, the system may use artificial intelligence and machine learning techniques to perform operations associated with implementations described herein. In various implementations, the system may use a machine learning model to implement various artificial intelligence and machine learning techniques.

In various implementations, the system may use a set of collected data for a training set to create and train the machine learning model. The training set may include known data patterns and sequences, and known outcomes. The system repeatedly evaluates the machine learning model, which generates predictions based on collected data, and adjusts outcomes based upon the accuracy of the predictions. In some implementations, the machine learning model may learn through training by comparing predictions to known outcomes. As training progresses, the predictions of the machine learning model become increasingly accurate. In various implementations, the machine learning model may be based on various classification methods for time series analysis models such as random forest (RF), naïve model, exponential smoothing Model, autoregressive moving average (ARIMA), seasonal autoregressive moving average (SARIMA), linear regression, etc. In some implementations, the machine learning model may be based on machine learning methods such as multi-layer perceptron, recurrent neural network, and/or long short-term memory, etc. In various implementations, once training and setup are complete and evaluations become satisfactory, the machine learning model may function as a decision engine that can render determinations and decisions used by the system for carrying out implementations described herein.

Implementations described herein provide various benefits. For example, implementations help to reduce unintentional media consumption making periodic reminders to the user of activities alternative to watching television.

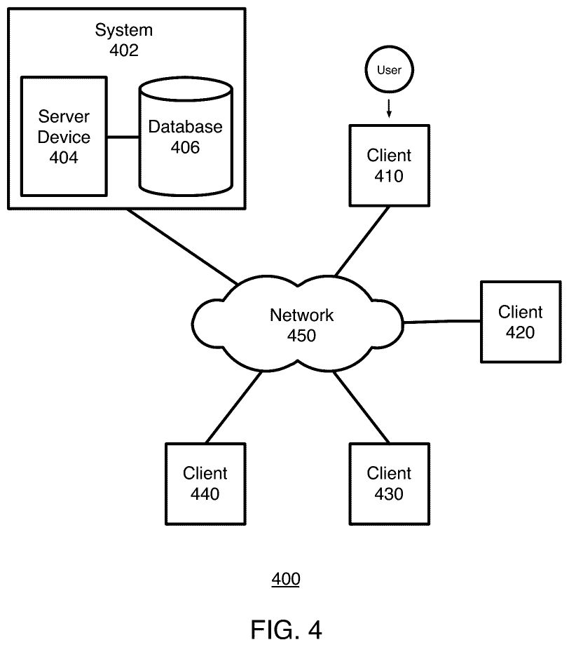

FIG. 4 is a block diagram of an example network environment 400, which may be used for some implementations described herein. In some implementations, network environment 400 includes a system 402, which includes a server device 404 and a database 406. For example, system 402 may be used to implement system 102 of FIG. 1, as well as to perform implementations described herein. Network environment 400 also includes client devices 410, 420, 430, and 440, which may communicate with system 402 and/or may communicate with each other directly or via system 402. Network environment 400 also includes a network 450 through which system 402 and client devices 410, 420, 430, and 440 communicate. Network 450 may be any suitable communication network such as a Wi-Fi network, Bluetooth network, the Internet, etc.

For ease of illustration, FIG. 4 shows one block for each of system 402, server device 404, and network database 406, and shows four blocks for client devices 410, 420, 430, and 440. Blocks 402, 404, and 406 may represent multiple systems, server devices, and network databases. Also, there may be any number of client devices. In other implementations, environment 400 may not have all of the components shown and/or may have other elements including other types of elements instead of, or in addition to, those shown herein.

While server device 404 of system 402 performs implementations described herein, in other implementations, any suitable component or combination of components associated with system 402 or any suitable processor or processors associated with system 402 may facilitate performing the implementations described herein.

In the various implementations described herein, a processor of system 402 and/or a processor of any client device 410, 420, 430, and 440 cause the elements described herein (e.g., information, etc.) to be displayed in a user interface on one or more display screens.

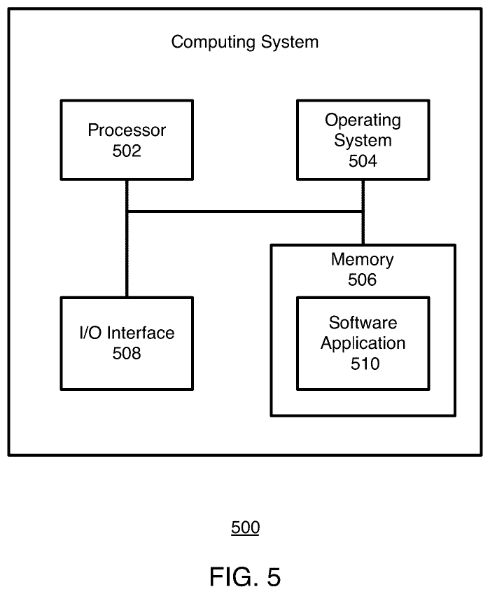

FIG. 5 is a block diagram of an example computer system 500, which may be used for some implementations described herein. For example, computer system 500 may be used to implement server device 404 of FIG. 4 and/or system 102 of FIG. 1, as well as to perform implementations described herein. In some implementations, computer system 500 may include a processor 502, an operating system 504, a memory 506, and an input/output (I/O) interface 508. In various implementations, processor 502 may be used to implement various functions and features described herein, as well as to perform the method implementations described herein. While processor 502 is described as performing implementations described herein, any suitable component or combination of components of computer system 500 or any suitable processor or processors associated with computer system 500 or any suitable system may perform the steps described. Implementations described herein may be carried out on a user device, on a server, or a combination of both.

Computer system 500 also includes a software application 510, which may be stored on memory 506 or on any other suitable storage location or computer-readable medium. Software application 510 provides instructions that enable processor 502 to perform the implementations described herein and other functions. Software application may also include an engine such as a network engine for performing various functions associated with one or more networks and network communications. The components of computer system 500 may be implemented by one or more processors or any combination of hardware devices, as well as any combination of hardware, software, firmware, etc.

For ease of illustration, FIG. 5 shows one block for each of processor 502, operating system 504, memory 506, I/O interface 508, and software application 510. These blocks 502, 504, 506, 508, and 510 may represent multiple processors, operating systems, memories, I/O interfaces, and software applications. In various implementations, computer system 500 may not have all of the components shown and/or may have other elements including other types of components instead of, or in addition to, those shown herein.

Although the description has been described with respect to particular implementations thereof, these particular implementations are merely illustrative, and not restrictive. Concepts illustrated in the examples may be applied to other examples and implementations.

In various implementations, software is encoded in one or more non-transitory computer-readable media for execution by one or more processors. The software when executed by one or more processors is operable to perform the implementations described herein and other functions.

Any suitable programming language can be used to implement the routines of particular implementations including C, C++, C #, Java, JavaScript, assembly language, etc. Different programming techniques can be employed such as procedural or object oriented. The routines can execute on a single processing device or multiple processors. Although the steps, operations, or computations may be presented in a specific order, this order may be changed in different particular implementations. In some particular implementations, multiple steps shown as sequential in this specification can be performed at the same time.

Particular implementations may be implemented in a non-transitory computer-readable storage medium (also referred to as a machine-readable storage medium) for use by or in connection with the instruction execution system, apparatus, or device. Particular implementations can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (SaaS) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular implementations have been described herein, latitudes of modification, various changes, and substitutions are intended in the foregoing disclosures, and it will be appreciated that in some instances some features of particular implementations will be employed without a corresponding use of other features without departing from the scope and spirit as set forth. Therefore, many modifications may be made to adapt a particular situation or material to the essential scope and spirit.

What is claimed is:

1. A system comprising:
one or more processors; and
logic encoded in one or more non-transitory computer-readable storage media for execution by the one or more processors and when executed operable to cause the one or more processors to perform operations comprising:
detecting a program being presented on a television;
recording a play time period that the television has been showing the program;
determining when the play time period meets a predetermined threshold value;
determining a target break point in the program in response to the play time period meeting the predetermined threshold value; and
presenting a reminder notification to a user during the target break point.

2. The system of claim 1, wherein the predetermined threshold value is a maximum of time before initiating a reminder event.

3. The system of claim 1, wherein the target break point is between a previous episode of the program and a next episode of the program.

4. The system of claim 1, wherein the predetermined threshold value is based on a number of episodes.

5. The system of claim 1, wherein the predetermined threshold value is based on a number of minutes.

6. The system of claim 1, wherein the reminder notification indicates the predetermined threshold value has been met.

7. The system of claim 1, wherein the user is a person watching the program on the television.

8. A non-transitory computer-readable storage medium with program instructions stored thereon, the program instructions when executed by one or more processors are operable to cause the one or more processors to perform operations comprising:
detecting a program being presented on a television;
recording a play time period that the television has been showing the program;
determining when the play time period meets a predetermined threshold value;
determining a target break point in the program in response to the play time period meeting the predetermined threshold value; and
presenting a reminder notification to a user during the target break point.

9. The computer-readable storage medium of claim 8, wherein the predetermined threshold value is a maximum of time before initiating a reminder event.

10. The computer-readable storage medium of claim 8, wherein the target break point is between a previous episode of the program and a next episode of the program.

11. The computer-readable storage medium of claim 8, wherein the predetermined threshold value is based on a number of episodes.

12. The computer-readable storage medium of claim 8, wherein the predetermined threshold value is based on a number of minutes.

13. The computer-readable storage medium of claim 8, wherein the reminder notification indicates the predetermined threshold value has been met.

14. The computer-readable storage medium of claim 8, wherein the user is a person watching the program on the television.

15. A computer-implemented method comprising:
detecting a program being presented on a television;
recording a play time period that the television has been showing the program;
determining when the play time period meets a predetermined threshold value;
determining a target break point in the program in response to the play time period meeting the predetermined threshold value; and
presenting a reminder notification to a user during the target break point.

16. The method of claim 15, wherein the predetermined threshold value is a maximum of time before initiating a reminder event.

17. The method of claim 15, wherein the target break point is between a previous episode of the program and a next episode of the program.

18. The method of claim 15, wherein the predetermined threshold value is based on a number of episodes.

19. The method of claim 15, wherein the predetermined threshold value is based on a number of minutes.

20. The method of claim 15, wherein the reminder notification indicates the predetermined threshold value has been met.
